(19) United States
(12) Patent Application Publication
(10) Pub. No.: US 2019/0047737 A1
(43) Pub. Date: Feb. 14, 2019

(54) MARKING DEVICE POSITIONING TOOL

(71) Applicant: ADHETEC, TARBES (FR)

(72) Inventors: Philippe Lanquete, Tarbes (FR); Alexis Fafournoux, Tarbes (FR)

(73) Assignee: ADHETEC, Tarbes (FR)

(21) Appl. No.: 16/076,863

(22) PCT Filed: Feb. 23, 2017
(86) PCT No.: PCT/EP2017/054195

§ 371 Date: Aug. 9, 2018

(30) Foreign Application Priority Data
Feb. 25, 2016 (FR) 1651565

(51) Int. Cl. B65C 9/26; B44C 1/10

(52) U.S. Cl. CPC B65C 9/262; B44C 1/105

(57) ABSTRACT

A tool for positioning at least one marking device on a substrate, the at least one marking device presenting a perimeter and the substrate comprising a reference part presenting a periphery. The tool comprises at least one alignment portion that is complementary to at least one part of the periphery of said reference part and at least one receiving portion, forming a perimeter complementary to at least one part of the perimeter of the at least one marking device, the receiving portion being configured to receive the at least one part of the perimeter of the at least one marking device in an adjusted manner.

### 1. TECHNICAL FIELD OF THE INVENTION

The invention relates to a tool for positioning at least one marking device on a substrate. The invention also relates to a method for positioning at least one marking device on a substrate.

### 2. TECHNOLOGICAL BACKGROUND

It is common to affix markings onto a substrate for informative or decorative purposes.

The use of adhesive marking devices is often a favoured solution.

During the use of adhesive marking devices, one of the main difficulties is the positioning of the marking on the substrate. Indeed, the marking device must generally have a precise position at a given place, yet it is difficult to stick it precisely in this position. The correct positioning of the marking device is all the more difficult when the marking device must be affixed by hand. A manual application of the marking devices is particularly met in the aeronautical field where the application of such devices cannot be industrialised. Correctly positioning a certain number of marking devices thus represents a considerable loss of time for operators responsible for the marking. In addition, when highly technical marking devices, or marking devices with a very specific marking are used, an incorrect positioning of the latter obliges them to be removed, at the risk of damaging them, leading to an extra cost, because of this.

### 3. AIMS OF THE INVENTION

The invention aims to overcome the above-mentioned disadvantages.

The invention thus aims to provide, in at least one embodiment of the invention, a tool and a method which enable to affix a marking device at a specific given position.

The invention also aims to provide, in at least one embodiment, a tool and a method which enable an operator to affix marking devices quickly and with a limited risk of error.

The invention also aims to provide, in at least one embodiment of the invention, a tool and a method which enable an operator in charge of the marking, to easily know in which place of the substrate a marking device must be affixed. The operator thus no longer needs a map to position the markings.

### 4. SUMMARY OF THE INVENTION

To do this, the invention relates to a tool for positioning at least one marking device on a substrate at a given place, the marking device presenting a perimeter and the substrate comprising a reference part presenting a periphery, characterised in that the tool comprises:
at least one portion, called alignment portion, complementary to at least one part of the periphery of said reference part, and
at least one portion, called receiving portion, forming an edge complementary to at least one part of the perimeter of at least one marking device, the receiving portion being configured to be able to receive the at least one part of the perimeter of the at least one marking device making contact in an adjusted manner.

This easy-to-use tool enables to perfectly position a marking device. In addition, during a manual positioning, the operator in charge of the marking no longer needs to use a map or to memorise the location of the marking device. Indeed, positioning the marking device only requires the identification of the reference part. Once this part has been identified, the positioning of the marking device on the substrate is done automatically thanks to the tool.

The invention also relates to a marking kit comprising at least one tool according to the invention and at least one marking device. The tool and the marking device(s) being grouped in one same kit, the task of the marking operator is simplified and quicker.

The invention also relates to a method for positioning at least one marking device on a substrate at a given place, the marking device presenting a perimeter and the substrate comprising a reference part presenting a periphery characterised in that the method comprises steps of:
affixing the tool according to the invention onto the substrate such that the at least one portion for aligning the tool moulds the at least one part of the periphery of said reference part to which it is complementary,
affixing the at least one marking device onto the substrate with the at least one part of the perimeter of the marking device being received marking contact in an adjusted manner by the at least one receiving portion. The method is simple and quick. It makes it possible to affix, quickly and without risk of error, a marking device at a given place.

### 5. DETAILED DESCRIPTION

In the context of the invention, “marking” means one or more marks such as letter, figure, symbol, drawing, image, etc.

Preferably, the marking device is an adhesive marking device. The marking device can, for example, be a marking device by label, by adhesive transfer, or by a stencil system. The marking device can further comprise a handling sheet. The marking device can comprise a handling sheet placed on the upper face thereof and intended to facilitate the application of the latter. Preferably, the marking device is not a positioning tool per se.

The positioning of the marking device on the substrate is preferably a manual positioning. Indeed, the tool according to the invention is particularly adapted for positionings which cannot be achieved automatically.

The substrate onto which the marking device is intended to be affixed can, for example, be an aircraft. The marking device can thus be affixed outside or inside the aircraft. It can be for identification, control, security or decorative purposes. Usually, the positioning of marking devices on aircrafts is achieved manually. Operators in charge of the marking must quickly place numerous markings. In addition, the surfaces on which operators must position the marking devices are often extended. The tool according to the invention enables to avoid these limitations that are typical of the aeronautical field by enabling to quickly position numerous markings on extended surfaces, and without the help of a map. In addition, the tool according to the invention decreases the risk of error and because of this, limits the danger that could represent the incorrect positioning of a marking, in particular, a marking for security purposes.

The reference part can be any element of the substrate. Preferably, the reference part is a part that is easily identifiable by the operator in charge of the marking. Thus, the operator can effortlessly identify the location of the reference part and using the tool according to the invention, correctly position the marking device. In the case where the substrate is an aircraft, the reference part can, for example, be a window or a gripping part such as a handle, a lever, a button, etc. According to a preferred embodiment, the reference part is embossed. Thus, it is simpler to make the alignment portion come into contact in an adjusted manner, against the part of the reference part which itself is complementary.

Advantageously, the tool is adhesive and repositionable. Thus, it can be stuck to the substrate in a reversible way.

According to a preferred embodiment, the tool is rigid. To do this, the tool can comprise a rigid layer in order to rigidify it. The rigidity of the tool facilitates the gripping of the tool and enables a better affixing of the tool onto the substrate.

The alignment portion of the tool is complementary to at least one part of the periphery of said reference part. The alignment portion is thus configured to mould the at least one part of the periphery of the reference part to which it is complementary. The part of the periphery of the part to which the alignment portion is complementary is preferably not a straight line. The alignment portion can be complementary, fully or partially, to the reference part. Preferably, the alignment portion is only complementary to one part of the reference part. The tool is thus less bulky.

According to an embodiment, the tool can be transparent. The alignment portion thus forms a line, complementary to at least one part of the reference part. This line can, for example, be drawn on the tool. The alignment portion is thus configured to be placed transparently against the at least one part of the reference part, when the tool is affixed onto the substrate.

According to a preferred embodiment, the alignment portion forms an edge. Thus, the alignment portion forms an edge, complementary to said at least one part of the periphery of said reference part. It is configured to come into contact in an adjusted manner against said at least one part of the periphery of said reference part, when the tool is affixed onto the substrate. The alignment portion forms at least one part of an edge of the tool. The edge formed by the alignment portion thus moulds the part of the periphery of the reference part to which the alignment portion is complementary. The adjusted contact of the tool with the reference part enables the correct positioning of the tool on the substrate.

Advantageously, the tool is intended to be affixed onto the substrate at a given direction. This given direction can be determined by the complementarity between the alignment portion and the part of the reference part to which it is complementary, in other words, once the alignment portion of the tool makes contact in an adjusted manner against the at least one part of the reference part, the complementarity is such that the tool can only be at a given direction. Generally, the direction wherein the tool is affixed onto the substrate can easily be determined by the operator in charge of the marking. Preferably, the given direction is the vertical or horizontal direction.

Further to the alignment portion, the tool comprises a receiving portion. The receiving portion differs from the alignment portion. The receiving portion is complementary to at least one part of the at least one marking device. Typically, the receiving portion forms an edge. The at least one marking device also presents an edge. The edge formed by the receiving portion is configured to mould the edge of the part of the marking device to which the receiving portion is complementary. The part of the at least one part of the at least one marking device to which the reference portion is complementary, is preferably not a straight line.

The receiving portion can be complementary, fully or partially, to the marking device. Preferably, the receiving portion is only complementary to one part of the at least one marking device. The tool is thus less bulky.

The receiving portion is configured to be able to receive the at least one part of the perimeter of the at least one marking device making contact in an adjusted manner. The receiving portion can therefore receive the at least one marking device, with which it thus makes contact in an adjusted manner. The receiving portion is typically configured such that when the tool is affixed onto the substrate with the alignment portion making contact in an adjusted manner against said reference part, the at least one marking device making contact in an adjusted manner against the receiving portion is positioned at said given place. Thus, once the tool is affixed onto the substrate with respect to the reference part, the operator no longer only has to affix the marking device at the level of the receiving portion and the marking device is thus positioned at the desired given place.

The tool can comprise, at the level of the at least one receiving portion, at least one marker configured to be opposite at least one corresponding marker of the at least one marking device when the at least one marking device is received making contact in an adjusted manner by the receiving portion. When the tool is affixed onto the substrate with the alignment portion making contact in an adjusted manner against said reference part, and when the marking device is positioned on the substrate at the given place, the at least one marker of the tool is opposite the at least one corresponding marker of the at least one marking device. These markers enable to precisely position the at least one marking device. They enable to give an additional control to the operator in charge of the marking. Thus, the markers enable to rectify the position of a marking device which would be placed in contact with the receiving portion, being slightly offset.

The tool can comprise an intermediate portion connecting the alignment portion and the receiving portion. The intermediate portion is typically configured such that the tool is affixed onto the substrate with the alignment portion making contact in an adjusted manner against said reference part, the at least one marking device received in contact in an adjusted manner through the receiving portion is positioned at said given place of the substrate.

The invention also relates to a marking kit comprising at least one tool according to the invention and at least one marking device.

One tool and the at least one device that this tool is intended to position, can be grouped together, for example, within one positioning set. Typically, a positioning set therefore comprises a tool for positioning at least one marking device and said at least one marking device. The positioning set can comprise a support.

In a preferred embodiment, the at least one tool and the at least one marking device comprise the same support. Storage is simplified. The operator has, at the same time, the tool and the marking device(s). In addition, the tool and the at least one marking device can be positioned on the support so as to explain to the operator, the position that each one of these elements will have on the substrate. For example, each marking device is placed on the support so as to be received in contact in an adjusted manner by the at least one receiving portion of the tool. Thus, the operator will clearly see how each marking device is positioned with respect to the tool. In addition, the support can comprise a schematic reproduction of the reference part against which the at least one alignment portion of the tool makes contact in an adjusted manner. Thus, the operator will identify each reference part and will clearly see how each tool is positioned with respect to the latter.

Advantageously, the support on which are placed the tool and/or the at least one marking device is rigid which facilitates the handling of the product.

According to a preferred embodiment, the tool and the at least one marking device are stuck to the same support with a repositionable adhesive.

The kit can comprise several positioning sets. These positioning sets can comprise at least one support on which are placed the positioning tool and/or the at least one marking device. The latter can, in particular, be stuck on the at least one support reversibly. According to an embodiment, the latter are placed on one same support. The different positioning sets of one same kit can be placed within this kit so as to explain to the operator, the position that each one of these sets will have on the substrate.

The positioning sets can be detachable. For example, the kit can comprise preformed dotted lines defining a detachable section corresponding to a positioning set.

The positioning set can comprise a detachable tool and/or at least one detachable marking device. The tool and/or the marking device can therefore be detached from the positioning set. For example, the tool can be detached from the positioning set. To do this, the positioning set can comprise preformed dotted lines defining a detachable section corresponding to a detachable tool and/or at least one detachable marking device. The detachable tool and/or the at least one detachable marking device can also comprise a repositionable adhesive and be detachable by unsticking each one of these elements.

The invention also relates to a method for positioning at least one marking device on a substrate at a given place, the substrate comprising a reference part.

The method comprises a first step of affixing the tool according to the invention onto the substrate, such that the at least one portion for aligning the tool moulds the at least one part of the periphery of said reference part to which it is complementary. According to a preferred embodiment, the tool is stuck reversibly to the substrate.

When the positioning tool is detachable, the method can comprise a step of detaching the tool from the positioning set. According to a preferred embodiment, this detachment step is prior to the step of affixing the tool onto the substrate.

Advantageously, the tool is affixed onto the substrate at a predetermined given direction. This given direction can be determined by complementarity between the alignment portion and the reference part. Generally, the direction wherein the tool is affixed onto the substrate can easily be determined by the operator in charge of the marking. Preferably, the given direction is the vertical or horizontal direction.

According to a preferred embodiment, the step of affixing the tool onto the substrate comprises a step of putting in contact, in an adjusted manner, the alignment portion against said at least one part of the periphery of said reference part. In this embodiment, the alignment portion forms an edge. It is configured to be able to make contact, in an adjusted manner, against at least one part of the reference part to which it is complementary.
The method further comprises a step of affixing at least one marking device onto the substrate with the at least one part of the perimeter of the marking device being received in contact, in an adjusted manner, by the at least one receiving portion.

According to an embodiment, the at least one receiving portion comprises at least one marker configured to be opposite at least one corresponding marker of the at least one marking device, when the at least one marking device is received in contact in an adjusted manner by the receiving portion, and the method comprises the step of affixing the at least one marking device onto the substrate, such that each marker of the at least one receiving portion is opposite each corresponding marker of the marking device. The method thus comprises the step of affixing at least one marking device onto the substrate, such that each marker of the tool is opposite each corresponding marker of the marking device. The markers enable to correctly align the marking device with respect to the tool. According to a preferred embodiment, the markers are on the handling sheet of the marking device. The handling sheet is, preferably, removed when the marking device is positioned on the substrate. The markers are therefore no longer visible once the application sheet has been removed.

Advantageously, the method also comprises a step of removing the tool from the substrate. Once the marking device(s) is/are positioned, the tool can be removed. The removal of the tool can be done easily using the repositionable adhesive.

### 6. LIST OF FIGURES

The embodiments and variants will be defined below, as non-limiting examples, with reference to the affixed drawings, wherein:

FIG. 1 is a schematic view of a tool according to an embodiment of the invention,

FIG. 2 is a schematic view of a tool making contact in an adjusted manner against a reference part according to an embodiment of the invention,

FIG. 3 is a schematic view of a tool making contact in an adjusted manner against a reference part and receiving a marking device according to an embodiment of the invention.

### 7. DETAILED DESCRIPTION OF AN EMBODIMENT OF THE INVENTION

In the figure, the scales and proportions are not strictly adhered to, and this, for illustration and clarity purposes.

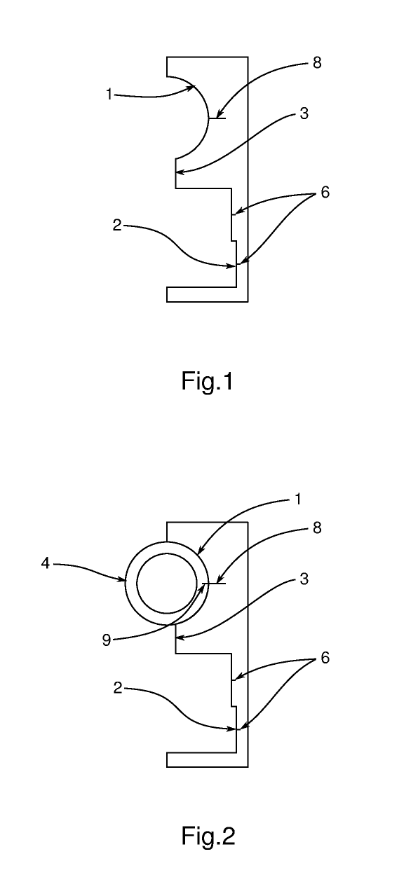

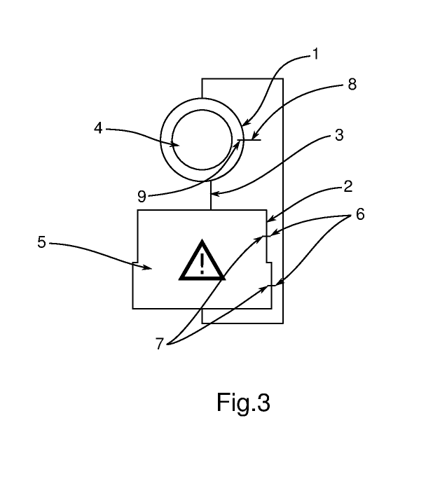

The tool represented in FIG. 1 is a tool for positioning a marking device 5 on a substrate at a given place. The substrate comprises a reference part 4. The tool comprises an alignment portion 1, an intermediate portion 3 and a receiving portion 2.

The alignment portion 1 is constituted of a part of the edge of the tool. It is in the shape of a semi-circle.

The receiving portion 2 is also constituted of a part of the edge of the tool.

The intermediate portion 3 connects the alignment portion 1 to the receiving portion 2.

The tool comprises a marker 8 at the level of the alignment portion 1. The marker 8 is a straight line.

The tool also comprises two markers 6 at the level of the receiving portion 2. These two markers are also straight lines.

In FIG. 2, the tool illustrated in FIG. 1 is represented, whereas it is affixed onto the substrate. The tool makes contact with a reference part 4. The reference part 4, represented schematically, is a window. The alignment portion 1 is in the shape of a semi-circle. Because of the shape and the dimensions thereof, it is complementary to half of the reference part 4 which it presents a periphery in the shape of a circle. The tool is affixed onto the substrate with the alignment portion 1 thereof, which makes contact in an adjusted manner against the reference part 4. The semi-circle that forms the alignment portion 1 makes contact with half of the circle that forms the periphery of the reference part 4. The tool is positioned along a vertical direction. The marker 8 situated at the level of the alignment portion 1 enables to precisely position the tool with respect to the reference part 4. Indeed, the reference part 4 also has a marker 9 which is a straight line. The markers 8 and 9 are each configured so as to be found, one opposite the other, when the tool is correctly affixed onto the substrate.

In FIG. 5, the marking device 5 is affixed onto the substrate. The receiving portion 2 forms an edge. This edge is complementary to half of the perimeter of the marking device 5. The marking device 5 is received in an adjusted manner by the receiving portion 2. The marking device is thus correctly positioned on the substrate, in other words, it is positioned at the given place of the substrate where it was intended to be affixed. Such that this positioning is even more precise, the marking device 5 comprises markers 7. These markers 7 are lines. They are put opposite the markers 6 of the tool which are at the level of the receiving portion 2. The marking device 5 is thus perfectly positioned on the substrate. The tool can thus be removed from the substrate.

1. A tool for positioning at least one marking device on a substrate, the at least one marking device presenting a perimeter and the substrate comprising a reference part presenting a periphery, the tool comprising:
at least one alignment portion, complementary to at least one part of the periphery of said reference part; and
at least one receiving portion, forming an edge complementary to at least one part of the perimeter of the at least one marking device, the at least one receiving portion being configured to receive the at least one part of the perimeter of the at least one marking device making contact in an adjusted manner.

2. The tool according to claim 1, wherein the alignment portion forms an edge configured to make contact in an adjusted manner against said periphery of said reference part, when the tool is affixed onto the substrate.

3. The tool according to claim 1, wherein the tool is adhesive and repositionable.

4. The tool according to claim 1, wherein the at least one receiving portion comprises at least one marker configured to be opposite at least one corresponding marker of the at least one marking device, when the at least one marking device is received in contact in an adjusted manner by the at least one receiving portion.

5. A positioning set comprising at least one tool according to claim 1 and at least one marking device.

6. The positioning set according to claim 5, wherein the at least one tool and the at least one marking device are detachable.

7. A kit comprising a positioning set according to claim 5.

8. A method for positioning at least one marking device on a substrate, the marking device presenting a perimeter and the substrate comprising a reference part presenting a periphery, the method comprising:
affixing the tool according to claim 1 onto the substrate, such that the at least one alignment portion moulds the at least one part of the periphery of said reference part to which it is complementary; and
affixing the at least one marking device onto the substrate with at least one part of the perimeter of the marking device being received in contact in an adjusted manner by the at least one receiving portion.

9. The method according to claim 8, wherein affixing the tool onto the substrate comprises putting into contact, in an adjusted manner, the at least one alignment portion against said periphery of said reference part.

10. The method according to claim 8,
wherein the at least one receiving portion comprises at least one marker configured to be opposite a corresponding marker of the at least one marking device, when the at least one marking device is housed in contact in an adjusted manner against the receiving portion,
wherein affixing the at least one marking device onto the substrate comprises affixing the at least one marking device (5) onto the substrate such that each marker of the at least one receiving portion is opposite each corresponding marker of the at least one marking device.
